(19) United States
(12) Patent Application Publication
(10) Pub. No.: US 2024/0193518 A1
(43) Pub. Date: Jun. 13, 2024

(54) PROCESS AUTOMATION MONITORING AND CONTROL

(71) Applicant: SAP SE, Walldorf (DE)

(72) Inventors: Alexandre Fortin, Paris (FR); Jaber Lounes, Offemont (FR)

(21) Appl. No.: 18/065,108

(22) Filed: Dec. 13, 2022

(51) Int. Cl. G06Q 10/0633

(52) U.S. Cl. CPC G06Q 10/0633

(57) ABSTRACT

In some implementations, there is provided a computer-implemented method that includes providing a first user interface to obtain release information for an automated workflow, wherein the first user interface further includes a release user interface element that in response to selection of the release user interface element generates an indication; in response to a detection of the indication, receiving a message to initiate a review and a monitor of the automated workflow; in response to the message, monitoring of the automated workflow by at least accessing and/or generating a plurality of metrics associated with the automated workflow; and in response to the monitoring, causing, based on the plurality of metrics, one or more actions with respect to the automated workflow. Related systems, methods, and articles of manufacture are also disclosed.

### TECHNICAL FIELD

This disclosure relates generally to cloud technology.

### BACKGROUND

Database management systems have become an integral part of many computer systems. For example, some systems handle hundreds if not thousands of transactions per second (which in-turn can generate over time a large volume of corresponding data). On the other hand, some systems perform very complex multidimensional analysis on data. In both cases, the underlying database may need to handle responses to queries very quickly in order to satisfy systems requirements with respect to transaction time. Given the complexity of these queries and/or their volume, the underlying databases face challenges in order to optimize performance including use of resources as well as monitor and control of automated workflows associated with the databases as well as other systems.

### SUMMARY

In some aspects there is provided a first user interface to obtain release information for an automated workflow, wherein the first user interface further includes a release user interface element that in response to selection of the release user interface element generates an indication. Moreover, in response to a detection of the indication, a message may be received which initiates a review and a monitor of the automated workflow. And, in response to the message, the automated workflow may be monitored by at least accessing and/or generating a plurality of metrics associated with the automated workflow. In response to the monitoring, one or more actions may be caused with respect to the automated workflow.

In some variations, one or more of the features disclosed herein including the following features can optionally be included in any feasible combination. The one or more actions may include generating a second user interface depicting at least a portion of the plurality of metrics. The one or more actions may include receiving an approval or a denial of the automated workflow for the deployment to the one or more cloud platforms via the second user interface. The automated workflow may be developed via a process automation monitor and control system and/or a process automation development tool. The automated workflow may be stored in a project repository coupled to the process automation monitor and control system. The plurality of metrics may include overall project metrics, collaboration project metrics, internal project metrics, runtime project metrics, and/or transport and approval metrics. The plurality of metrics may be stored in the project repository. The message may be received by a process automation monitor and control system. In response to the process automation monitor and control system receiving the message, a second user interface may be generated including a task list of one or more tasks requiring approval via the process automation monitor and control system, a reject user interface element, and/or a approve user interface element. The message may include the indication, a location of the automated workflow, a copy of the automated workflow, and/or release information about the automated workflow. The automated workflow may include a plurality of workflow steps, each of which includes at least one artifact.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local arca network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a diagram illustrating an example of a system including a process automation monitor and control (PAMC) system, in accordance with some embodiments;

FIG. 2A depicts an example of a workflow being developed, in accordance with some embodiments;

FIG. 2B depicts an example of a user interface where the release of a workflow may be triggered, in accordance with some embodiments;

FIGS. 2C, 2D, and 2E depict examples of user interfaces generated by the PAMC for presentation at a client device, in accordance with some embodiments;

FIG. 2F depicts an example implementation of the PAMC, in accordance with some embodiments;

FIG. 3A depicts an example of a workflow monitoring process, in accordance with some embodiments;

FIG. 3B depicts an example of a workflow release process, in accordance with some embodiments; and

FIG. 4 depicts another example of a system, in accordance with some embodiments.

### DETAILED DESCRIPTION

In some systems, such as an enterprise resource planning (ERP) system, processes, such as workflows, may be automated and provided as a service, application, and/or the like. In a simple example, a purchase request approval process may include receiving a purchase request, reviewing the purchase request, approving the purchase request, and after the good or service for the purchase request is received, paying the purchase request. In this simple workflow, there may several end users involved in the automated workflow and each of the steps may involve artifacts, such as logic, view logic, script, operations (e.g., database operations, scans, etc.), data objects (which may be stored in a database instance), and/or the like. Moreover, a company may have dozens and dozens if not hundreds and hundreds of such workflows.

Some workflows may be developed by a more sophisticated end user, such as an IT professional. But often a workflow (or portion of a workflow) may be developed at least in part by a less sophisticated end user using, for example, visual programming tools. In either case, the ability for end user to develop (e.g., create, modify, and/or the like) a service providing a workflow may result in increased efficiency with respect to utilization of compute resources and in decreased latency (e.g., increased response times), for example. And, it may empower a company (which may represent a tenant at a cloud platform) including end users accessing the service providing the workflow. But the company or tenant owner of the service providing the workflow(s) may need to monitor, control, review, and/or approve this development process. To that end, there is provided, in some embodiments, a process automation monitor and control (PAMC) system that is used to at least monitor the development of process automation workflows as well as other services, applications, and/or the like, at a tenant's cloud platform, and the PAMC may control whether the automated workflow is released for use to other users via the cloud platform.

Before providing additional details regarding the process automation monitor and control (PAMC) system, the following provides an example of a system environment.

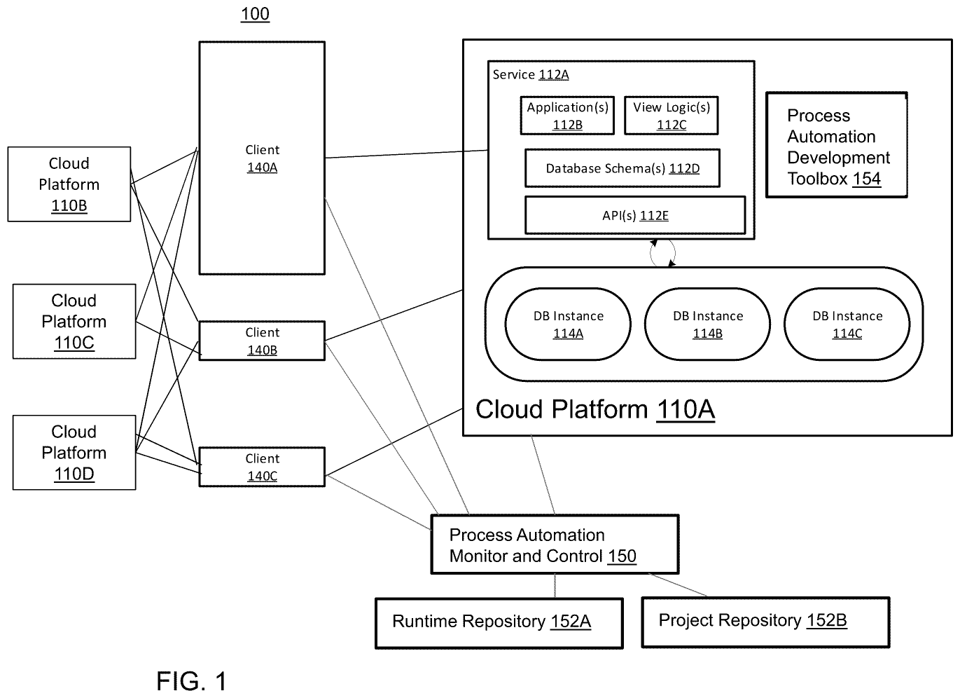

FIG. 1 depicts a diagram illustrating an example of a system 100 consistent with some implementations of the current subject matter. Referring to FIG. 1, the system 100 may include a plurality of cloud platforms 110A-D. Each of the cloud platforms may provide resources that can be shared among a plurality of tenants. For example, the cloud platforms 110A-D may be configured to provide a variety of services including, for example, software-as-a-service (SaaS), platform-as-a-service (PaaS), infrastructure as a service (IaaS), database as a service (DaaS), and/or the like, and these services can be accessed by one or more tenants (labeled clients) of the cloud platform.

In the example of FIG. 1, the system 100 includes a first tenant 140A, a second tenant 140B, and a third tenant 140C, although other quantities of tenants (which as noted are labeled as clients) may be implemented as well on the cloud platform 110A. For example, an end user may access the client 140A (also referred to as client device), and the client may comprise a user device (e.g., a computer including an application such as a browser or other type of application). And, the clients may each access, via the Internet and/or other type of network or communication link(s), at least one of the services at a cloud platform, such as cloud platform 110A-D. In some implementations, each of the clients (and/or tenants) 140A-C represents a separate tenant at the cloud platform 110A for example, such that a tenant's data is not shared with other tenants (absent permission from a tenant). For example, tenant 140A may correspond to company A, while tenant B may correspond to another company. Alternatively, each of the tenants 140A-C may represent a single tenant at the cloud platform 110A, such that the tenants do share a portion of the tenant's data, for example.

The system 100 may also include a process automation monitor and control system (PAMC) 150. The PAMC may at least monitor one or more workflows developed by end users. The workflow may represent a service, such as service 112A (and/or other service at the cloud platform), an application, and/or the like. Alternatively, or additionally, the PAMC may control whether an automated workflow can be released so other users of the cloud platform can use the automated workflow. The system 100 may also include a process automation development toolbox 154, which may provide a software development toolkit to develop workflows (which may be developed by the end user at least in part based on a graphical or visual development tool).

The PAMC 150 may couple to a runtime repository 152A and a project repository 152B. The runtime repository 152A may include information, such as metrics representative of an overview of all of the workflow projects being monitored by the PAMC, collaboration metrics for the workflow projects, and/or other metrics including key performance indicators (KPIs) for the workflow projects. The project repository 152B may include a copy of the developed workflow or at least a link to the workflow (e.g., an identification or an address of the workflow, or the service or application providing the service). For example, the project repository 152B may, as noted, store workflow projects in the form of an editable version of a workflow project, and the stored workflow projects may be viewed, accessed, shared, and/or modified by the PMAC 150 (and/or a process automation toolbox 154). A version of a workflow project may be published, which refers to releasing an executable version of the workflow project that can be used by other end-users. The project repository may be accessed and used by certain users that design and/or manage the design of workflow automation to enable the publication of an executable version of the automated workflow. The runtime repository may also store jobs, records, metadata (e.g., creation date of an automated workflow, last edit of an automated workflow, last read date of an automated workflow, last time modified of an automated workflow, quantity of reads of an automated workflow, version history of an automated workflow, and the like) related to a specific automated workflow (e.g., for a given version). The runtime repository may further include additional information, such as agents, variables, metrics, and the like (e.g., where the version of a workflow project is being used, and the like).

To illustrate by way of an example, when an end user develops a workflow automation (which may be provided by as the service 112A, an application, such as application 112B, and/or the like), this may be developed at least in part graphically using one or more artifacts, such as logic, view logic, script, operations (e.g., database operations, scans, etc.), data objects (which may be stored in a database instance), and/or the like. Before being deployed to enable productive use by other end users, the PAMC 150 may assess the developed workflow, approve the developed workflow, and release the workflow into production so that other end users can use the workflow. For example, a user may, via the PAMC, assess the developed workflow, approve the developed workflow, and release the workflow into production. Alternatively, or additionally, the PAMC may automatically approve and release the developed workflow (e.g., given rules or machine learning that assess the metrics of a given workflow). Thus, the PMAC not only monitors one or more metrics for a given workflow, but also provides a control system that controls whether to approve for release a given workflow (e.g., by publishing an executable copy of the automated workflow) for use in the enterprise, for example. The assessment may include evaluating one or more metrics associated with the developed workflow, and based on the assessment, the PAMC may approve the developed workflow. Moreover, from time to time, the PAMC may re-evaluate the workflow based on one or more metrics to determine whether the process automation workflow should still be allowed to be used in production. For example, a user may, via the PMAC, perform the reevaluation of the workflow. Alternatively, or additionally, the PMAC may automatically perform the re-evaluation (e.g., given rules or machine learning that assess the metrics of a given workflow).

The cloud platform 110A may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources.

In the case of a cloud platform being a so-called “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110A includes a service 112A, which is provided to for example the client 140A (or one of the other clients 140B). This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example. The client 140A (or other client) may also be accessed to develop the workflow. Alternatively, or additionally, the client 140A (or other client) may also be used to access the PAMC 150 and the service provided by the PAMC. Although FIG. 1 depicts the PAMC 150 and repositories 152A-B as being separate from the cloud platforms, such as cloud platform 110A, the PAMC 150 and repositories 152A-B may be implemented within one or more of the cloud platforms, such as cloud platform 110A, as well. For example, the PAMC may be provided as a service at the cloud platform with database instances to store the contents of the repositories 152A-B. And although the process automation development toolbox 154 is depicted within cloud platform 110A, the process automation development toolbox be implemented in other locations as well.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110A.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database 114A may be accessed as a service at a cloud platform, which may be the same or different platform from cloud platform 110A. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110A. Although the database instances are depicted at the same cloud platform 110A, one or more of the database instances may be hosted on another or separate platform (e.g., on premise) and/or another cloud platform. Moreover, the service provided at the cloud platform may include other types of applications, such user interface applications, and the like.

The cloud platforms 110A-D may (as noted) be implemented using different technologies. As such, a system having heterogeneous cloud platforms may include for example, deployments at a SAP cloud, Microsoft Azure™, Amazon Web Services™, Google Cloud Platform™ data centers, a private data center, and/or the like. The heterogeneous cloud platform technology represents a multi-cloud system. In the case of database instances and/or their clients, some may be deployed at different private data centers (each of which may have different cloud platform technology, protocols, and the like), while some may be deployed at private data centers.

Moreover, the databases instances at the cloud platform may rely on the same or different storage or database technology. For example, a database management system instance may be an online transaction processing (OLTP) system using a relational database system. An example of an OLTP system is the SAP S/4HANA™ enterprise resource planning (ERP) system. Furthermore, the database management system instance may operate using for example the same or different storage technology, such as a row-oriented database system, a column-oriented database system, or a hybrid row-column store approach. Alternatively, or additionally, the database management system instance may be for example an online analytic processing (OLAP) system. Applications of OLAP systems include business reporting for sales, marketing, management reporting, business process management (BPM), budgeting, forecasting, financial reporting, and/or other types of analytics. An example of the OLAP system is the SAP BW/4HANA™ data warehouse solution, which can be used to for example answer multi-dimensional analytical (MDA) queries.

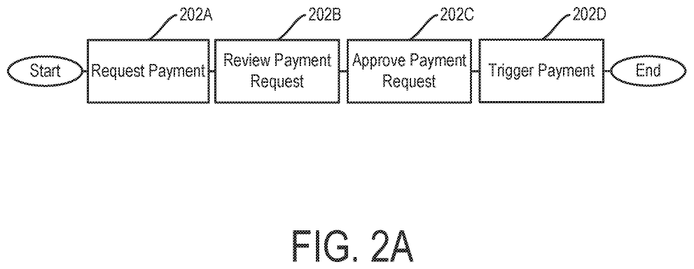

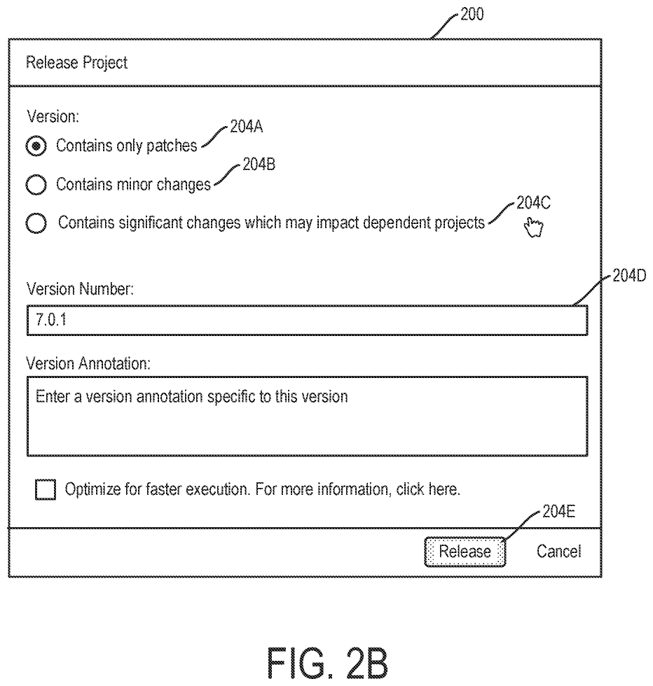

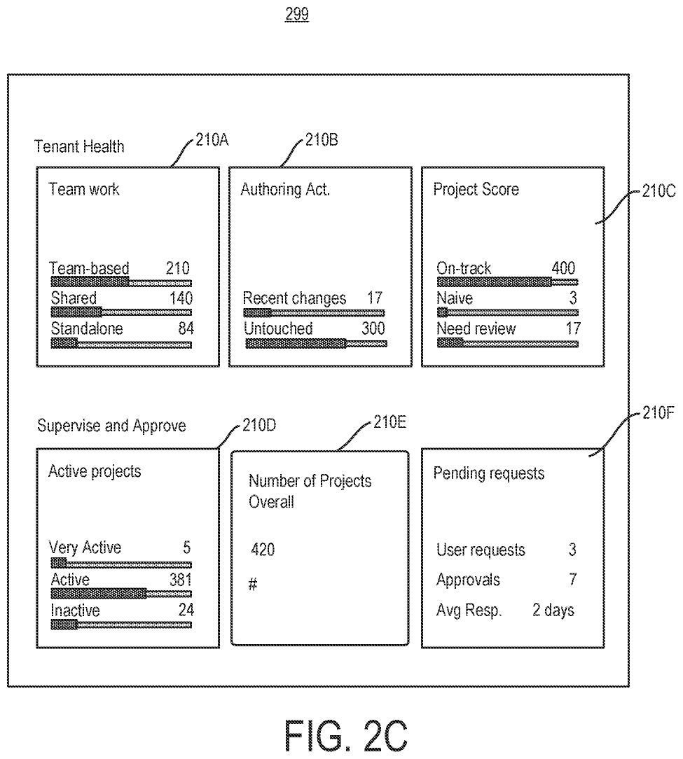

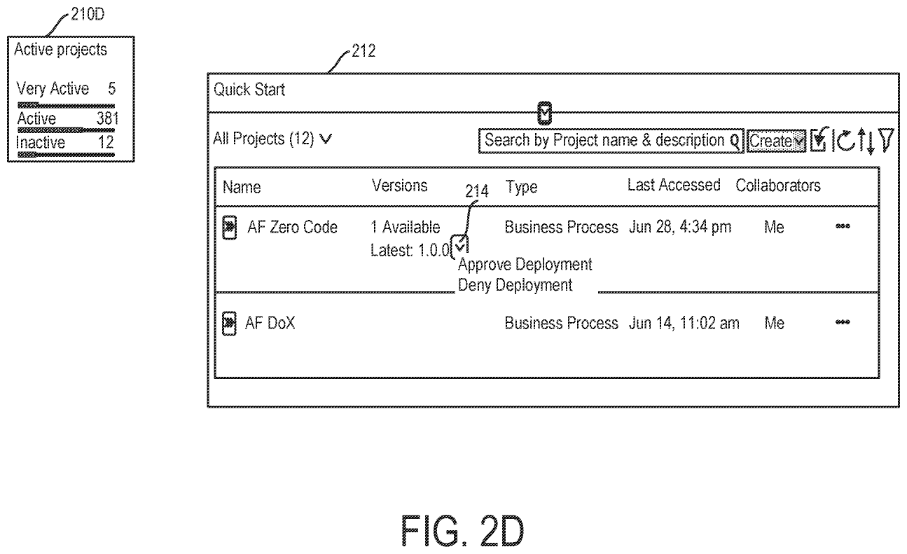

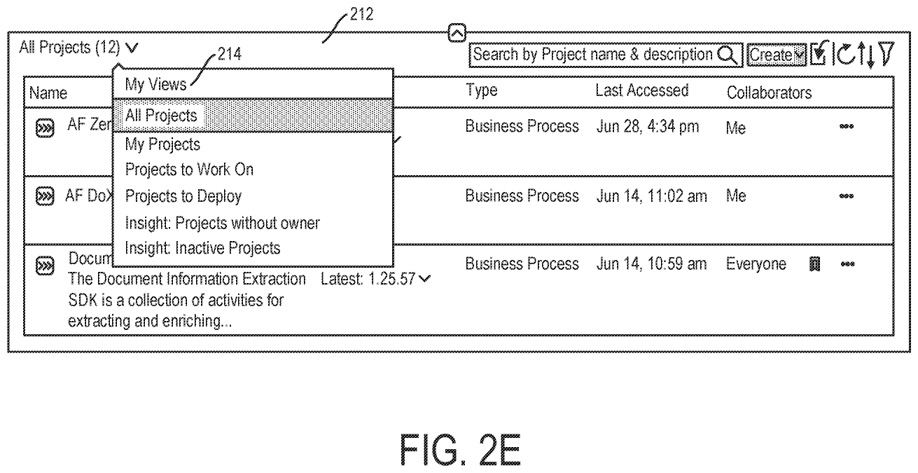

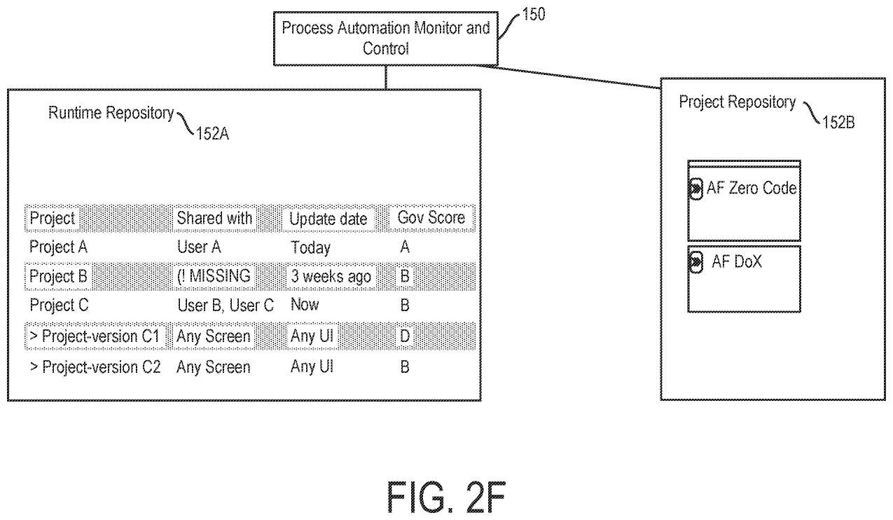

FIG. 2A depicts an example of a workflow 202A-D, in accordance with some embodiments. The workflow may be include one or more steps, and each of the steps may corresponds to artifacts, such as logic, view logic, script, operations (e.g., database operations, scans, etc.), data objects (which may be stored in a database instance), and/or the like. In some instances, the workflow may be developed at least in part using a graphical software development tools to enable a broader base of end users to develop the workflow. The development may be a modification of an existing workflow or created from so-called scratch. For example, the workflow may represent a service or an application (e.g., service 112A, application 112B, and/or the like) that are made available at a cloud platform to one or more end users of a tenant of the cloud platform.

In the example of FIG. 2A, the workflow 202A-D includes an automation that includes the steps of request payment 202A, review payment request 202B, approve payment request 202C, and trigger payment 202D. As noted, each of the steps may include artifacts, such as logic, view logic, script, operations (e.g., database operations, scans, etc.), data objects (which may be stored in a database instance), and/or the like. For example, an end user developer may, via the client 140B, access the process automation development toolbox 154 (which may be located at cloud platform 110A or at another platform or location as well). And, the process automation development toolbox 154 may provide a user interface and a software development toolkit to develop the workflow 202A-D (which may be developed by the end user at least in part based on a graphical or visual development tool).

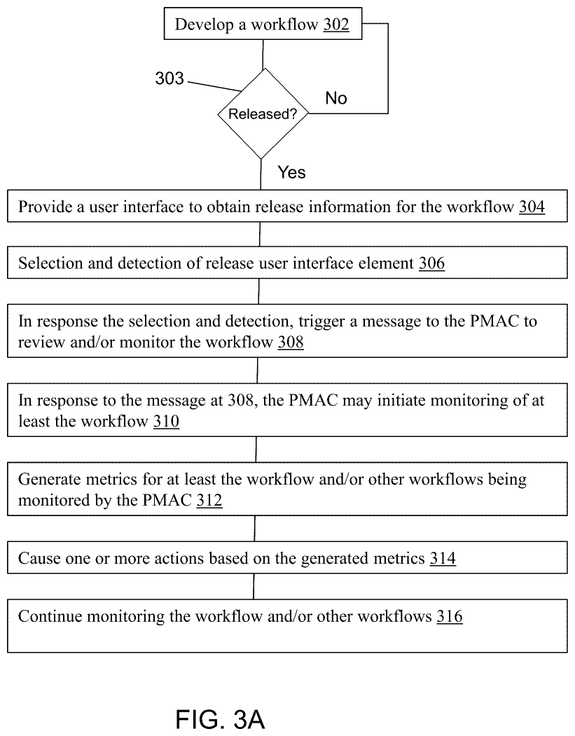

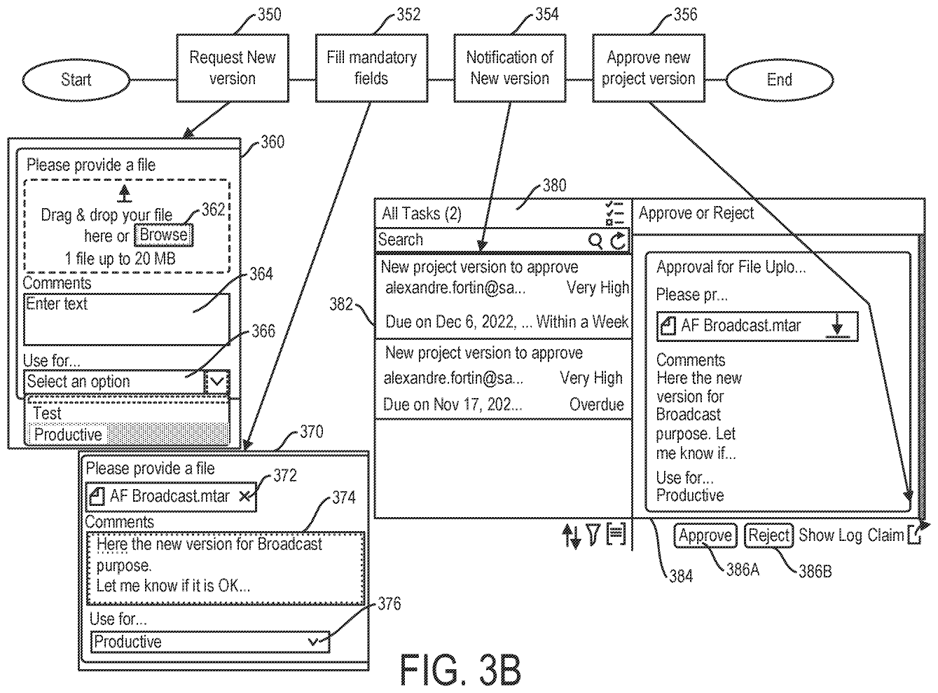

When the developer, end user is ready to release (e.g., publish) the workflow into production (which refers to the workflow being used by other end users in operational use to perform the workflow 202A-D, for example), the end user may release the workflow by providing information about the workflow project as shown at FIG. 2B (as well as user interface 360 at FIG. 3B). FIG. 2B depicts an example of a user interface 200, which may be presented (at for example the client 140B) to the end user developer of the workflow being developed at FIG. 2A. To release the workflow project, the user interface includes workflow version user interface element(s) 204A-C. For example, user interface element 204A may be selected to indicate the workflow development is a patch information, user interface element 204B may be selected to indicate the workflow development is a minor change, and user interface element 204C may be selected to indicate the workflow development is a major change which impacts other workflow projects. Based on the selection at 204A-C, the version number 204D may be completed by the process automation development toolbox 154 or the PAMC 150. For example, if the development is a patch 204A or a minor change 204B, the version 204D may increment just the least significant digit(s), but if the development is a major change, the most significant digit may be incremented (e.g., from a 7 to an 8). The user interface 200 may also allow free flow comments describing the development at 204D. When the user interface element 204E (“release user interface element”) is selected, the workflow project is released. The release may allow other end users of the tenant at the cloud platform to access the developed workflow. Alternatively, or additionally, the PAMC 150 may review and approve the workflow before the workflow is released and other end users (including the developer end user) of the tenant are allowed to access the workflow. For example, when the developer selects release 204E, this may trigger a message to be sent to the PAMC 150 to review (and/or monitor) the developed workflow. Alternatively, or additionally, when the developer selects release 204E, this may trigger a message to be sent to the process automation development toolbox 154, which in turn may send the message (indicating a request to release the workflow) to the PAMC 150 to review (and/or monitor) the developed workflow. The message may include one or more of the following: an indication that the release 204E was selected (e.g., detection of the selection of the user interface element 204E) and release information (e.g., 204A-D, a copy (or location) of the automated workflow, and/or the like).

The PAMC 150 may review the developed workflow and/or monitor developed workflows. For example, the PAMC may receive the noted message and then proceed to review the workflow. The review may cause the PAMC to access one or more metrics associated with the workflow. Based on the metrics, the PAMC may approve the developed workflow, so other end users can access the developed workflow. For example, the PAMC may generate a user interface that is presented at a client device (along with the one or more metrics), such that a user can select a user interface element to approve or deny for the automated workflow for release (e.g., publication). Alternatively, or additionally, the PMAC may automatically approve and deny the developed workflow using rules or machine learning that assess the one or more metrics of a given automated workflow. Once approved, the PAMC may from time to time review, based on one or more metrics, the developed workflow to assess whether the workflow should continue to be made available end users.

To review the workflow, the PAMC 150 may collect metrics. For example, the PAMC may store (e.g., in the runtime repository 152A) logic for the collection of one or more metrics. For example, the PAMC may define the one or more metrics and store the metrics in the runtime repository 152A. The PAMC may collect the metrics, which may be associated with (e.g., mapped) to the workflow(s) being developed as well as other workflows, which may be stored in the project repository 152B. Moreover, a metric may be associated with a rule, a threshold, logic, and/or a machine learning model to evaluate the metric (e.g., to determine whether to approve or deny publication of the automated workflow).

The PAMC 150 may collect metrics, such as KPIs, which provide insight regarding the workflows to for example an administrator, tenant owner, and/or other user (including the end user that developed the workflow/service). The metrics may be collected and associated with workflows when evaluating the developed workflow(s). The metrics may be viewed at a client device in the form of a dashboard, for example. The metrics may be viewed on a user interface to provide insight regarding the workflow development, trigger alerts regarding a workflow, and/or indicate whether a given workflow should be approved for production (or denied/prevented) from productive use by other end users.

In some embodiments, different types of metrics may be collected by the PAMC 150. For example, the metrics may include overall project metrics, collaboration project metrics, internal (or inside) project metrics, runtime project metrics, and transport and approval metrics. The metrics may be generated automatically, and some of the metrics may be computed in real-time while some metrics may be computed from time to time. Alternatively, or additionally, the PMAC may access runtime metrics from the cloud platform 110A, such as memory usage of a workflow automation, CPU usage of a workflow automation, network bandwidth usage of a workflow automation, and/or storage usage of a workflow automation.

The overall project metrics may include metrics related to the overall collection of projects being monitored by the PAMC 150. The overall project metrics may be stored in the runtime repository 152A. For example, an overall project metric may include the number of workflow projects (which have been developed or are in the process of being developed) that are being monitored by the PAMC. Table 1 depicts a summary of the overall project metrics used by the PAMC to evaluate a workflow.

Alternatively, or additionally, the overall project metrics may include recent or new workflow projects, which may indicate a count of all of the workflow projects created within the last 7 days (or some other time frame).

Alternatively, or additionally, the overall project metrics may include an inactive workflow projects. For example, the inactive projects may be a count of workflow projects that have not been accessed by an end user for productive use within the past 30 days (or some other time frame).

Alternatively, or additionally, the overall project metrics may include a count of inactive projects with respect to authoring or runtime. For example, the inactive projects with respect to authoring or runtime may be a count of projects not accessed for the past 90 days or not triggered for the past 90 days (or some other time frame). For example, if the author (e.g., end user developer) of the workflow has not accessed the workflow (or run the workflow) for a given timeframe, such as 90 days or other timeframe, this may be flagged as a metric. An active project may refer to a workflow project that receives frequent updates from a contributor. By contrast, an inactive project may be a workflow project which has not been updated for a given time. However, a workflow project (which has not been updated for the given time but still in productive, regular, runtime use (e.g., daily, weekly, monthly, and/or the like)) may not be considered an inactive project if the workflow project is operating and used by end users without failures. And, an inactive project (which has not updated) and no longer used in runtime (or has failure issues) may be classified as obsolete. If a very active project is used intensively (e.g., more than a threshold amount of usage per day, week, or month), the very active workflow project may be monitored more carefully by the PMAC 150 as end users rely on the very active workflow project, when compared to a less active workflow.

Alternatively, or additionally, the overall project metrics may include a recently changed project count, such as a count of projects which have been changed in some way (e.g., a modification, update, and/or the like) during the past 7 days (or some other time frame).

TABLE 1
Overall Project Metrics

| Metrics | Description |
|---|---|
| Number of projects | Count of ALL projects |
| | (increasing/decreasing/quota. . . ) |
| Recent new projects | Count of projects created in the |
| | last 7 running days |
| Inactive projects | Count of projects untouched for |
| | the past 30 days |
| Inactive projects | Count of projects untouched for the past 90 |
| (authoring or runtime) | days or not triggered for the past 90 days |
| Recently changed | Count of projects which have changed |
| projects | during the past 7 days |

The collaboration project metrics may be related to the collection of workflow projects and the collaboration among end users accessing or using the workflows. For example, the collaboration metrics may include a count of the workflows projects that are classified as standalone (e.g., standalone). A standalone project is a workflow that is not shared with other users (so used by only a single user). From the perspective of the PAMC 150, a workflow that is standalone may have less usefulness, and, as such, not as worthy of resources, when compared to a workflow that is used by a group or team of users. Table 2 depicts a summary of the collaboration project metrics used by the PAMC to evaluate a workflow.

Alternatively, or additionally, the collaboration project metrics may include a count of workflow projects that are shared projects. For example, the count of a workflow projects shared with at least 2 (or a threshold quantity of) other end users, so that the other end users can use the workflow.

Alternatively, or additionally, the collaboration project metrics may include a count of workflow projects that are team projects. For example, the count of a workflow projects shared with a team of 5 (or a threshold quantity of) other end users.

Alternatively, or additionally, the collaboration project metrics may include a count of workflow projects that are classified as orphan projects. For example, the count of workflow projects where the owner (e.g., person responsible for the workflow) is not (or cannot be) identified by the PAMC and/or the owner is no longer with the company or tenant. From the perspective of the PAMC, an orphan project may be a candidate for at the very least closer monitoring if not denying (e.g., removing) from deployment so it can no longer be used.

TABLE 2
Collaboration project metrics

| Metrics | Description |
|---|---|
| Standalone projects | Count of projects unshared |
| Shared projects | Count of projects shared at least |
| | with 2 persons |
| Team projects | Count of projects shared at least |
| | with 5 persons or more |
| Orphan Projects | Count of projects without owner |
| | (or owner has left) |

The inside (or internal) project metrics may include metrics related to the internals of a workflow. For example, an inside or internal project metrics may include a count of workflow projects classified as naïve workflow projects, which are workflow projects that contain less than a threshold number (e.g., 5) of artifacts. For example, a workflow that includes less than 5 artifacts maybe classified as naïve. From the perspective of the PAMC, a workflow that is naïve may have less usefulness, and, as such, not as worthy of resources, when compare to a workflow that is not naïve. Table 3 depicts a summary of the inside (or internal) project metrics used by the PAMC to evaluate a workflow.

Alternatively, or additionally, the inside project metrics may include a count of projects classified as need review, and these need review projects may contain processes with more than a threshold quantity of steps.

Alternatively, or additionally, the inside project metrics may include a count of projects classified as oversized, and these oversized projects may classified as oversized when the workflow project exceeds a threshold size (in terms of memory consumed, for example).

TABLE 3
Inside Project Metrics

| Metrics | Description |
|---|---|
| Naive projects | Count of projects which contain |
| | less than 5 artifacts |
| Need review | Count of projects which contain |
| projects | automations or processes with |
| | steps exceeding a threshold amount |
| | of steps. |
| Oversized projects | Count of projects which are “too big” |

The runtime project metrics may relate to the overall count of projects deployed and in use. Table 4 below depicts a summary of the runtime project metrics. For example, a runtime project metric may include a count of active workflow projects, which are workflow projects that have been triggered at least once during a threshold amount of time (e.g., the last 95 days or other time frame).

Alternatively, or additionally, the runtime project metrics may include a count of inactive projects that have been not triggered at least one during a threshold amount of time (e.g., the last 120 days or other time frame).

Alternatively, or additionally, the runtime project metrics may include a count of very active projects that have been triggered more than a threshold amount of times over a given timeframe. For example, a workflow project that is accessed for use more than an average (which is an average amount of uses across all the work flow projects) may be classified as a very active work flow project.

TABLE 4
Runtime Project Metrics

| Metrics | Description |
|---|---|
| Active projects | Count of projects which has |
| | been triggered at least once |
| | during the past 95 days |
| Inactive projects | Count of projects which has |
| | not been triggered at least once |
| | during the past 120 days |
| Very Active | Count of projects which have |
| projects | been triggered above the average |

Alternatively, or additionally, the runtime project metrics may include a count of very active projects that have been triggered more than a threshold amount of times over a given timeframe. For example, a workflow project that is accessed for use more than an average (which is an average amount of uses across all the work flow projects) may be classified as a very active work flow project. From the perspective of the PAMC 150, a workflow that is very active may have more usefulness, and, as such, more likely to be kept as a deployed workflow.

The PAMC 150 may collect and/or generate the metrics by monitoring the workflows (both workflows in development and workflows deployed and thus in product use) at the cloud platform (as well as other cloud platforms in the case of the tenant using multiple cloud platforms). The collected metrics may, as noted, be defined by a client via the PAMC, and may be stored as part of the monitoring of the workflows. Alternatively, or additionally, the metrics may be associated rules, machine learning models, logic, and/or thresholds, to monitor and/or evaluate a metric associated with an automated workflow. For example, a machine learning model may evaluate some if not all of the metrics for an automated workflow, and this machine leaning model may output an indication of whether to approve or deny the automated workflow. This indication may be used to automatically (e.g., without end user intervention) approve or deny the automated workflow. Alternatively, or additionally, the indication may be presented via a user interface, such that an end user can select via the user interface the indication to approve or deny the publication or release of the automated workflow. Alternatively, or additionally, logic (which may include rules) may be used to evaluate some if not all of the metrics for an automated workflow.

Moreover, each metric may be presented on a user interface along with a link or a user interface element to enable an end user (e.g., developer, tenant owner, administrator, and/or the like) to trigger an action, such as approve deployment of the workflow, disapprove deployment of the workflow, and/or continue monitor the workflow (e.g., as in the case of a workflow that is under development and not yet ready for deployment). Furthermore, metrics (and/or threshold related to the metrics) may be defined or updated by a client device via the PAMC 150 and deployed for use (via for example, the cloud platform and/or PAMC).

FIG. 2C depicts an example of a user interface 299 generated by the PAMC 150 for presentation at a client device, such as client device 140B. The user interface may be generated based on the collected metrics for the workflows being monitored by the PAMC. For example, the user interface may depict one or more of the collaboration metrics at user interface element 210A (which in this example is a tile).

Moreover, the user interface 299 may depict one or more overall project metrics (such as recently changed or inactive projects) at user interface element 210B (which in this example is a tile).

Furthermore, the user interface 299 may depict a project score for the workflows at user interface element 210C. The project score targets the complexity of a project. For example, the project score may be generated based on the values of the one or more metrics. On-track may refer to a project that is not of concern for the PMAC (e.g., not naïve, no need a review, etc.), while the naive project may require refactoring, simplification, clarification and so on. A “naïve” project may be considered a workflow project with few artifacts. For example, a workflow project containing one step may be considered naïve. Likewise, a workflow automation project containing a one step process and nothing else may be considered naïve. To illustrate further, a workflow project having for example, one process, one start form, one approval form, a condition within the process, and two automations with at least a few steps might not be seen as naïve but might considered for review by the PMAC. While a workflow project having once process, one start form, one approval form, a condition within the process and two automations with a dozen of steps and has been tested multiple times may not be considered naïve.

In addition, the user interface 299 may include one or more user interface elements that provide runtime metrics (at 210D), an overall count of the workflow projects being monitored by the PAMC (at 210E), and a status of the pending requests from developer, end users to approve a workflow for deployment (at 210F) and, in particular, pending user requests (e.g., 3), approvals (e.g., 7), and a metric on how long it took to approve the request (e.g., 2 days).

When any of the tiles are selected at FIG. 2C, the PAMC 150 may generate additional details for the tile by accessing collected metrics stored at the runtime repository 152A. In the example of FIG. 2D, the user interface element 210D is selected, which triggers the PAMC to gather and generate a second user interface 212 with additional details for the active workflow projects listed at 210D (e.g., identity of the workflows such as AF Zero Code, Version of the workflow, type of workflow project, collaborators, and/or other information regarding the workflow projects). For example, the workflow being developed may be approved or denied via a user interface element 214 for deployment.

FIG. 2E depicts the user interface 212 with a filter function 214. The filter function may be selected to see all projects, my projects (which represents all workflow projects developed by the end user), projects to work on (e.g., workflow projects being developed), projects to deploy (e.g., workflow projects to be reviewed to deploy), project without owners (e.g., workflows classified as orphan projects), inactive projects (e.g., workflows classified as inactive projects), and/or other filter functions based on the value of a metric being collected by the PAMC.

FIG. 2F depicts an example of the PAMC 150 coupled to the runtime repository 152A and project repository 152B. The runtime repository may include a list of all of the workflows (labeled projects) mapped to associated metrics, such as end users accessing or sharing the workflow, last update, and/or any other metric being monitored, such as metrics described above with respect to Tables 1-4. The project repository may include a copy of the workflow being monitored or a link to the workflow being monitored.

FIG. 3A depicts an example of a process for monitoring workflows, in accordance with some embodiments. The process at FIG. 3A enables the PAMC 150 to provide governance and control (e.g., with respect to authorization to deploy) workflows being monitored by the PAMC.

At 302, a workflow may be developed. For example, an end user may develop the workflow, such as the workflow 202A-202D, and store the workflow in a landscape or repository, such as project repository 152B. The workflow may be created from scratch, represent a minor revision to a prior version of the workflow, or represent a more significant revision to a prior version (e.g., one that impacts other services and/or workflows). As the workflow 202A-202D is developed (which in the example of FIG. 2A is developed using a graphical development environment such as Visual Basic, the process automation development toolbox 154, and/or the like), the end user may select, via the client 140B for example, artifacts, such as logic, conditions, view logic, script, operations (e.g., database SQL operations, scans, etc.), data objects (which may be stored in a database instance), and/or the like, to configure each of the steps 202A-D of the workflow. Although the example workflow of FIG. 2A shows 4 steps, the workflow may have other quantities of steps as well. In some embodiments, the client 140B accesses the process automation development toolbox 154 to configure each of the steps 202A-D of the workflow. The workflow may be stored at a system landscape or repository, such as project repository 152B. When the workflow is not ready to be released (No at 303), the end user may continue to develop the workflow.

When the workflow is to be released (Yes at 303), a release user interface element may be provided at 304. For example, when the end user is wants to release the workflow being developed into production so other end users can access and thus use the workflow, the end user may receive, at the client 140B, a user interface, such as user interface 200 including a release user interface element 204E as well as other release information, such as information describing the workflow automation (e.g., version information 204A-D, comments, and/or other information about the release). Alternatively, or additionally, other user interfaces may be received, such as user interface 360-370 described below with respect to FIG. 3B. For example, the user interface 200 (and/or user interfaces 360/370) may be generated and/or provided by the process automation development toolbox 154 or the PAMC 150, such that other release information may be provided for the release of the workflow (sec, e.g., 362-366 and 372-376) at FIG. 3B. The end user may select, via client 140B for example, the release user interface element 204E to trigger the release of the workflow.

The release user interface element 204E selection may be detected at 306, and in response this may trigger, at 308, a message to the PAMC 150 (which receives the message) to initiate the review and monitor of the workflow. For example, the client device 140B being accessed by the end user may detect the selection of the release user interface element 204E. When this is the case, the client 140B may send a message to the PAMC 150 to initiate the PAMC's review and monitoring of the workflow. Alternatively, or additionally, when the developer selects release 204E, this may trigger a message to be sent to the process automation development toolbox 154, which in turn may send the message (indicating a request to release the workflow) to the PAMC 150 to review (and/or monitor) the developed workflow. The message may include a location of the workflow (e.g., a storage address, unique ID, etc. where the workflow is stored such as at the project repository 152B). Alternatively, the message may include a copy of the workflow itself. Alternatively, or additionally, the message may include additional release information about the workflow. The additional release information may include one or more of the information noted above with respect to 204A-D, a name of the workflow project. Alternatively, or additionally, additional release information may include an identity of the end user developer of the workflow, a date for the requested release, and/or other end users or collaborators for the development of the workflow.

In response to the message at 308, the PAMC 150 may initiate, at 310, monitoring of the workflow. To monitor the workflow, the PAMC may access and/or obtain any metrics available in the runtime repository 152A. For example, the PAMC may already have metrics associated with other deployed workflows which have been the subject of monitoring. Alternatively, or additionally, the PMAC may query the cloud platform 110A (or orchestrator therein) to obtain runtime metrics for the workflow, such as memory usage of a workflow automation, CPU usage of a workflow automation, network bandwidth usage of a workflow automation, and/or storage usage of a workflow automation.

At 312, the PAMC 150 may also generate metrics for workflow identified by message 308. For example, any metrics not present in the runtime repository may be generated. To illustrate further, the PAMC may evaluate the inside project metrics (as described above) as well as other metrics for the workflow. Alternatively, or additionally, the metrics may be associated rules, machine learning models, logic, and/or thresholds, to monitor and/or evaluate a metric associated with an automated workflow. In the case of a machine learning model for example, the machine learning model may evaluate some if not all of the metrics for an automated workflow, such that the output of the machine leaning model may provide an indication of whether to approve or deny the automated workflow. Likewise, logic (which may include rules and thresholds) may be used to evaluate some if not all of the metrics for an automated workflow.

At 314, the PAMC 150 may cause one or more actions based on the generated metrics. For example, the PAMC may generate user interfaces, such as user interfaces 212 and 299 depicting one or more metrics related to the workflow being developed as well as other workflows. Moreover, the PAMC may approve or deny the deployment of the workflow. Referring to FIG. 2D for example, the PAMC may generate user interface 212, which may be presented at a client device at which a user may approve or deny for deployment a workflow by selecting a user interface element 214. Alternatively, or additionally, the PMAC may automatically approve and deny the developed workflow using rules or machine learning that assess the metrics of a given workflow. For example, a machine learning model may provide an output based on the metrics, and the output may provide an indication of whether to approve or deny the automated workflow. This indication may be used to automatically (e.g., without end user intervention) approve or deny the automated workflow. Alternatively, or additionally, the indication may be presented via a user interface, such that an end user can select via the user interface the indication to approve or deny the publication or release of the automated workflow.

At 316, the PAMC may continue monitoring the workflow as well as other workflows to provide reevaluations of the workflow(s). For example, the PAMC may generate user interfaces, such as user interfaces 212 and 299 depicting one or more metrics related for some if not all of the workflows being monitored. If during the monitoring of a workflow, the PAMC may deny (e.g., stop) the deployment of the workflow so that it can no longer be accessed by end users. Referring to FIG. 2D, the workflow being developed may be denied via a user interface element 214, for example.

FIG. 3B depicts an example of a workflow release process, in accordance with some embodiments.

At 350, an end user may request from the PMAC 150 that a new version of a workflow be reviewed. When this is the case, the PMAC may generate (or cause to be presented) user interface 360 at a client device, such as client device 140B. When the user wants to release a new version of the workflow into production or test, the user interface 360 may be provided with a user interface element 362 where the workflow automation may be provided (e.g., via a link or drop and drag) for review by the PMAC 150 (and/or storage at the project repository 152B), a user interface element for comments 364 (e.g., a description relate to the version or workflow), and user interface element 366 indicating whether the workflow being provided is for a test release (e.g., released for testing) or a productive release (e.g., released for actual end user productive, operations). At 352, the PMAC may request from the end user one or more mandatory fields for the version of the workflow. When this is the case, the PMAC may generate (or cause to be presented) user interface 370 with a user interface element 372 where the workflow automation may be provided (e.g., for review by the PMAC 150 and/or for storage at the project repository 152B), a user interface elements for comments 374, and user interface element 376 indicating the workflow being provided is for productive use.

At 354-356, the new version of the workflow may provide a notification for the approval of a new version of a project workflow. For example, user interface 380 may be presented to a user of the PMAC 150 with a new version user interface element 382 indicating a task for the new version needing approval and a review user interface element 384 including information regarding the new version of the workflow as well as an approve 386A or reject icon 386B (which when selected signals that the new workflow is approved or rejected, respectively).

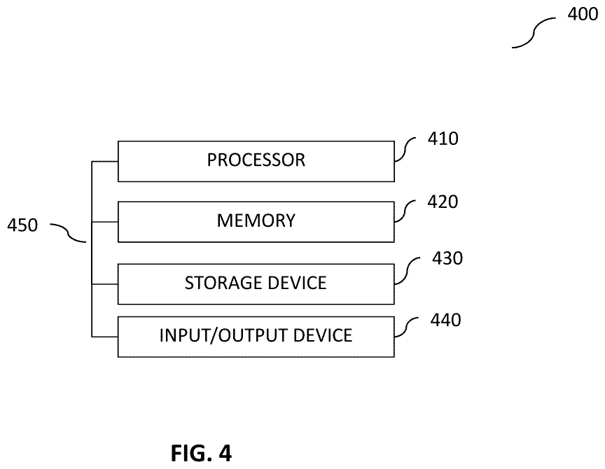

In some implementations, the current subject matter may be configured to be implemented in a system 400, as shown in FIG. 4. For example, the PAMC, process automation development toolbox, repositories, databases, and/or other aspects disclosed herein may be at least in part physically comprised on system 400. To illustrate further system 400 may further an operating system, a hypervisor, and/or other resources, to provide virtualize physical resources (e.g., via virtual machines). The system 400 may include a processor 410, a memory 420, a storage device 430, and an input/output device 440. Each of the components 410, 420, 430 and 440 may be interconnected using a system bus 450. The processor 410 may be configured to process instructions for execution within the system 400. In some implementations, the processor 410 may be a single-threaded processor. In alternate implementations, the processor 410 may be a multi-threaded processor.

The processor 410 may be further configured to process instructions stored in the memory 420 or on the storage device 430, including receiving or sending information through the input/output device 440. The memory 420 may store information within the system 400. In some implementations, the memory 420 may be a computer-readable medium. In alternate implementations, the memory 420 may be a volatile memory unit. In yet some implementations, the memory 420 may be a non-volatile memory unit. The storage device 430 may be capable of providing mass storage for the system 400. In some implementations, the storage device 430 may be a computer-readable medium. In alternate implementations, the storage device 430 may be a floppy disk device, a hard disk device, an optical disk device, a tape device, non-volatile solid state memory, or any other type of storage device. The input/output device 440 may be configured to provide input/output operations for the system 400. In some implementations, the input/output device 440 may include a keyboard and/or pointing device. In alternate implementations, the input/output device 440 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method, comprising:
providing a first user interface to obtain release information for an automated workflow, wherein the first user interface further includes a release user interface element that in response to selection of the release user interface element generates an indication;
in response to a detection of the indication, receiving a message to initiate a review and a monitor of the automated workflow;
in response to the message, monitoring of the automated workflow by at least accessing and/or generating a plurality of metrics associated with the automated workflow; and
in response to the monitoring, causing, based on the plurality of metrics, one or more actions with respect to the automated workflow.

Example 2: The computer-implemented of Example 1, wherein the one or more actions comprise generating a second user interface depicting at least a portion of the plurality of metrics.

Example 3: The computer-implemented method of any of Examples 1-2, wherein the one or more actions comprise receiving an approval or a denial of the automated workflow for the deployment to the one or more cloud platforms via the second user interface.

Example 4: The computer-implemented method of any of Examples 1-3, wherein the automated workflow is developed via a process automation monitor and control system and/or a process automation development tool.

Example 5: The computer-implemented method of any of Examples 1-4, wherein the automated workflow is stored in a project repository coupled to the process automation monitor and control system.

Example 6: The computer-implemented method of any of Examples 1-5, wherein the plurality of metrics include overall project metrics, collaboration project metrics, internal project metrics, runtime project metrics, and/or transport and approval metrics.

Example 7: The computer-implemented method of any of Examples 1-6, wherein the plurality of metrics are stored in the project repository.

Example 8: The computer-implemented method of any of Examples 1-7, wherein the message is received by a process automation monitor and control system.

Example 9: The computer-implemented method of any of Examples 1-8, wherein in response to the process automation monitor and control system receiving the message, generating a second user interface including a task list of one or more tasks requiring approval via the process automation monitor and control system, a reject user interface element, and/or an approve user interface element.

Example 10: The computer-implemented method of any of Examples 1-9, wherein the message includes the indication, a location of the automated workflow, a copy of the automated workflow, and/or release information about the automated workflow

Example 11: The computer-implemented method of any of Examples 1-10, wherein the automated workflow comprises a plurality of workflow steps, each of which includes at least one artifact.

Example 12: A system, comprising:
at least one processor; and
at least one memory including code, which when executed by the at least one processor causes operations comprising:
   providing a first user interface to obtain release information for an automated workflow, wherein the first user interface further includes a release user interface element that in response to selection of the release user interface element generates an indication;
   in response to a detection of the indication, receiving a message to initiate a review and a monitor of the automated workflow;
   in response to the message, monitoring of the automated workflow by at least accessing and/or generating a plurality of metrics associated with the automated workflow; and
   in response to the monitoring, causing, based on the plurality of metrics, one or more actions with respect to the automated workflow.

Example 13: The system of Example 12, wherein the one or more actions comprise generating a second user interface depicting at least a portion of the plurality of metrics.

Example 14: The system of any of Examples 11-13, wherein the one or more actions comprise receiving an approval or a denial of the automated workflow for the deployment to the one or more cloud platforms via the second user interface.

Example 15: The system of any of Examples 11-14, wherein the automated workflow is developed via a process automation monitor and control system and/or a process automation development tool.

Example 16: The system of any of Examples 11-15, wherein the automated workflow is stored in a project repository coupled to the process automation monitor and control system.

Example 17: The system of any of Examples 11-16, wherein the plurality of metrics include overall project metrics, collaboration project metrics, internal project metrics, runtime project metrics, and/or transport and approval metrics.

Example 18: The system of any of Examples 11-17, wherein the plurality of metrics are stored in the project repository.

Example 19: The system of any of Examples 11-18, wherein the message is received by a process automation monitor and control system.

Example 20. A non-transitory computer-readable storage medium including code which when executed by at least one processor causes operations comprising:
providing a first user interface to obtain release information for an automated workflow, wherein the first user interface further includes a release user interface element that in response to selection of the release user interface element generates an indication;
in response to a detection of the indication, receiving a message to initiate a review and a monitor of the automated workflow;
in response to the message, monitoring of the automated workflow by at least accessing and/or generating a plurality of metrics associated with the automated workflow; and
in response to the monitoring, causing, based on the plurality of metrics, one or more actions with respect to the automated workflow.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor eache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
providing a first user interface to obtain release information for an automated workflow, wherein the first user interface further includes a release user interface element that in response to selection of the release user interface element generates an indication;
in response to a detection of the indication, receiving a message to initiate a review and a monitor of the automated workflow;
in response to the message, monitoring of the automated workflow by at least accessing and/or generating a plurality of metrics associated with the automated workflow; and
in response to the monitoring, causing, based on the plurality of metrics, one or more actions with respect to the automated workflow.

2. The computer-implemented method of claim 1, wherein the one or more actions comprise generating a second user interface depicting at least a portion of the plurality of metrics.

3. The computer-implemented method of claim 2, wherein the one or more actions comprise receiving an approval or a denial of the automated workflow for the deployment to the one or more cloud platforms via the second user interface.

4. The computer-implemented method of claim 1, wherein the automated workflow is developed via a process automation monitor and control system and/or a process automation development tool.

5. The computer-implemented method of claim 4, wherein the automated workflow is stored in a project repository coupled to the process automation monitor and control system.

6. The computer-implemented method of claim 5, wherein the plurality of metrics include overall project metrics, collaboration project metrics, internal project metrics, runtime project metrics, and/or transport and approval metrics.

7. The computer-implemented method of claim 6, wherein the plurality of metrics are stored in the project repository.

8. The computer-implemented method of claim 1, wherein the message is received by a process automation monitor and control system.

9. The computer-implemented method of claim 8, wherein in response to the process automation monitor and control system receiving the message, generating a second user interface including a task list of one or more tasks requiring approval via the process automation monitor and control system, a reject user interface element, and/or an approve user interface element.

10. The computer-implemented method of claim 1, wherein the message includes the indication, a location of the automated workflow, a copy of the automated workflow, and/or release information about the automated workflow.

11. The computer-implemented method of claim 1, wherein the automated workflow comprises a plurality of workflow steps, each of which includes at least one artifact.

12. A system, comprising:
at least one processor; and
at least one memory including code, which when executed by the at least one processor causes operations comprising:
providing a first user interface to obtain release information for an automated workflow, wherein the first user interface further includes a release user interface element that in response to selection of the release user interface element generates an indication;
in response to a detection of the indication, receiving a message to initiate a review and a monitor of the automated workflow;
in response to the message, monitoring of the automated workflow by at least accessing and/or generating a plurality of metrics associated with the automated workflow; and
in response to the monitoring, causing, based on the plurality of metrics, one or more actions with respect to the automated workflow.

13. The system of claim 12, wherein the one or more actions comprise generating a second user interface depicting at least a portion of the plurality of metrics.

14. The system of claim 13, wherein the one or more actions comprise receiving an approval or a denial of the automated workflow for the deployment to the one or more cloud platforms via the second user interface.

15. The system of claim 12, wherein the automated workflow is developed via a process automation monitor and control system and/or a process automation development tool.

16. The system of claim 15, wherein the automated workflow is stored in a project repository coupled to the process automation monitor and control system.

17. The system of claim 16, wherein the plurality of metrics include overall project metrics, collaboration project metrics, internal project metrics, runtime project metrics, and/or transport and approval metrics.

18. The system of claim 17, wherein the plurality of metrics are stored in the project repository.

19. The system of claim 12, wherein the message is received by a process automation monitor and control system.

20. A non-transitory computer-readable storage medium including code which when executed by at least one processor causes operations comprising:
providing a first user interface to obtain release information for an automated workflow, wherein the first user interface further includes a release user interface element that in response to selection of the release user interface element generates an indication;
in response to a detection of the indication, receiving a message to initiate a review and a monitor of the automated workflow;
in response to the message, monitoring of the automated workflow by at least accessing and/or generating a plurality of metrics associated with the automated workflow; and
in response to the monitoring, causing, based on the plurality of metrics, one or more actions with respect to the automated workflow.
